(19) United States
(12) Patent Application Publication
(10) Pub. No.: US 2012/0254531 A1
(43) Pub. Date: Oct. 4, 2012

(54) STORAGE APPARATUS AND STORAGE CONTROL DEVICE

(75) Inventors: Kazuhiro URATA, Kawasaki (JP); Kazuo Nakashima, Kawasaki (JP)

(73) Assignee: Fujitsu Limited, Kawasaki (JP)

(21) Appl. No.: 13/357,926

(22) Filed: Jan. 25, 2012

(30) Foreign Application Priority Data
Mar. 28, 2011 (JP) 2011-071115

(51) Int. Cl. G06F 12/02; G06F 12/08

(52) U.S. Cl. 711/113; 711/E12.019; 711/E12.002

(57) ABSTRACT

A storage apparatus configured to store data received from a host system in a drive unit includes a memory unit partitioned into a cache area configured to temporarily store data read out from the drive unit and data to be written in the drive unit and an information storage area assigned for a memory pool configured to hold information for internal processing of the storage apparatus; an information-storage-area management table in which information-storage-area management information including position information on the memory pool in the memory unit is registered; a cache-area management table in which cache-area management information including usage status of the cache area is registered; and a memory control unit configured to acquire a memory area in the cache area having the least amount of write pending data in a pending state for writing in the drive unit by referring to the cache-area management table.

### CROSS-REFERENCE TO RELATED APPLICATION

This application is based upon and claims the benefit of priority of the prior Japanese Patent Application No. 2011-71115, filed on Mar. 28, 2011, the entire contents of which are incorporated herein by reference.

### FIELD

The embodiment discussed herein is related to a storage apparatus and a storage control device used for internal control of the storage apparatus.

### BACKGROUND

The recent development of information infrastructure has allowed a daily increase in the amount of data handled at companies, etc. Accordingly, the use of storage area network/network attached storage (SAN/NAS) type storage apparatuses has rapidly spread for storing important information, such as customer data and order data.

A storage apparatus includes a large-volume storage device having a plurality of hard disc drives (HDDs) and reads out and writes in data from and to the HDDs in response to requests from a host system, such as a server.

Such a storage apparatus, which is known as redundant arrays of inexpensive disks (RAID), is a fundamental part of the information infrastructure of a social system. Hence, it is desirable for storage apparatuses to have high reliability and high availability such that the settings of the apparatuses are flexibly changed during continuous operation.

Storage apparatuses have a cache memory that is accessible at speed higher than that of the HDDs in the storage device, so as to improve the performance of the entire system by carrying out high-speed data transfer.

Such a storage apparatus temporarily stores data read out from a storage device to the cache memory and accesses the cache memory if desired data is present in the cache memory, so as to increase processing speed by decreasing the number of times the HDDs in the storage device are accessed.

The number of times the HDDs in the storage device are accessed may be decreased if the volume of the cache memory is large to increase the speed of processing. However, semiconductor memories, which are used as cache memory, have a more expensive bit cost than that of HDDs.

The cache memory is also used as a memory for storing, for example, control data and management data used by the operating system of the storage apparatus. Hence, the volume of cache memory that may be actually used for cache is limited.

In such a cache memory, a system memory area used for management by the operating system and firmware of the storage apparatus (system area), a memory area in which management information and control information used for carrying out internal processing of the storage apparatus, such as management and control, are stored (information storage area), and a memory area used as cache (cache area) are set when power of the storage apparatus is turned on.

Specifically, in operation of the storage apparatus, memory areas are set such that a desired volumes of the system area and information storage area (hereinafter referred to as “table area”) are secured and set such that the remaining volume is used as the cache area. The table area is a collection of areas managed by tasks (layers) of firmware, which are referred to as memory pools, and holds main information of the firmware.

Then, the number of memory pools and the maximum possible size of each memory pool are calculated, and the addresses and sizes of physical memories to be allocated in the future are defined on the basis the number and size. When the memory pools are to be used, the areas assigned in advance are acquired from the cache area and used (refer to Japanese Laid-open Patent Publications Nos. 2006-107054, 2003-196152, and 08-202611).

### SUMMARY

In accordance with an aspect of the embodiments, a storage apparatus configured to store data received from a host system in a drive unit includes a memory unit partitioned into a cache area configured to temporarily store data read out from the drive unit and data to be written in the drive unit and an information storage area assigned for a memory pool configured to hold information for internal processing of the storage apparatus, an information-storage-area management table in which information-storage-area management information including position information on the memory pool in the memory unit is registered, a cache-area management table in which cache-area management information including usage status of the cache area is registered; and a memory control unit configured to acquire a memory area in the cache area having the least amount of write pending data in a pending state for writing in the drive unit by referring to the cache-area management table when the memory pool is allocated in the memory unit while the storage apparatus is in operation, to allocate the memory pool in the acquired memory area, and to set the allocated memory pool in the information-storage-area management table.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a block diagram of a computer system;

FIG. 2 illustrates the configuration of firmware of a disk array apparatus;

FIG. 3 is a functional block diagram of a controller module;

FIG. 4 is a schematic view of the allocation of table areas;

FIG. 5 illustrates a sequence of memory-pool assignment when power is turned on;

FIG. 6 illustrates memory-pool assignment when power is turned on;

FIG. 7 illustrates a sequence of memory-pool allocation;

FIG. 8 illustrates memory-pool allocation;

FIG. 9 illustrates a sequence of memory-pool reduction;

FIG. 10A illustrates a table-area management table; and FIG. 10B illustrates a cache-area management table;

FIG. 11 is a diagram illustrating a determination flow in an acquired-request cache area;

FIGS. 12A and 12B are schematic views of memory-pool allocation and reduction.

### DESCRIPTION OF EMBODIMENT

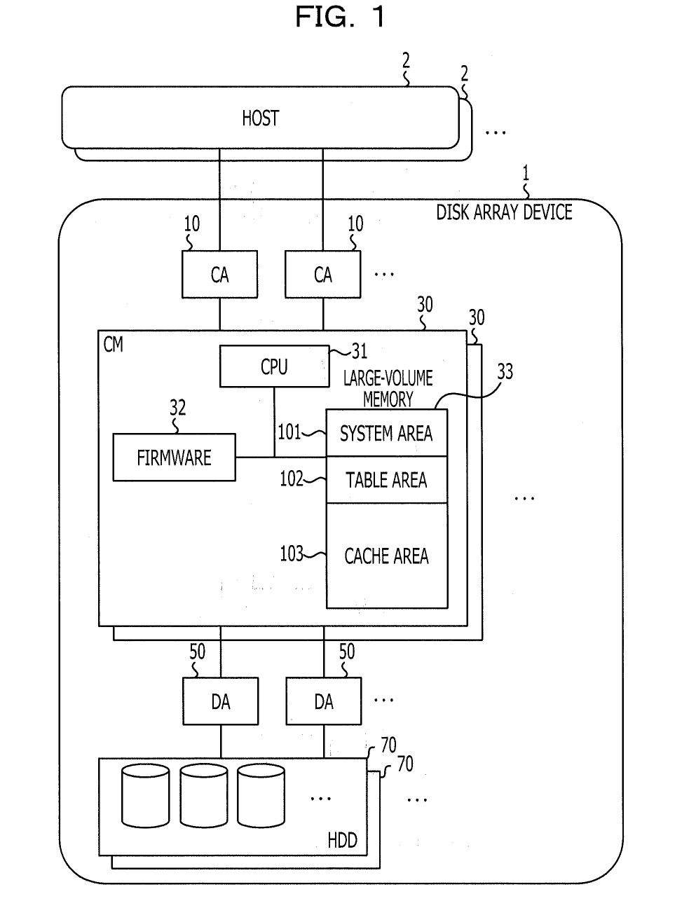

The embodiment will be described below with reference to the drawings. FIG. 1 is a block diagram of a computer system. A disk array apparatus (RAID) 1, which is an example storage apparatus, includes channel adapters (CA) 10, which control the connection with host systems 2 (which may also simply be referred as hosts 2), and controller modules (CM) 30, which control the entire apparatus.

Each controller module 30, which is an example storage control device, includes a CPU 31, firmware 32, and a large-volume memory 33, which is an example memory unit. The CPU 31 carries out various types of control based on instructions from the operating system, etc.

The disk array apparatus 1 includes drive units 70, and device adapters (DA) 50, which control the connection between the controller modules 30 and the corresponding drive units 70.

Each device adapter 50 controls the connection between each controller module 30 and the corresponding drive unit 70. The device adapter 50 has at least two different channels for establishing the redundancy in such a manner similar to each channel adapter 10. Each drive unit 70 includes at least one hard disk drive (HDD) and holds data sent from the corresponding host.

FIG. 1 illustrates pluralities of channel adapters 10, controller modules 30, device adapters 50, drive units 70, and hosts 2. The actual number of each component, however, is arbitrary.

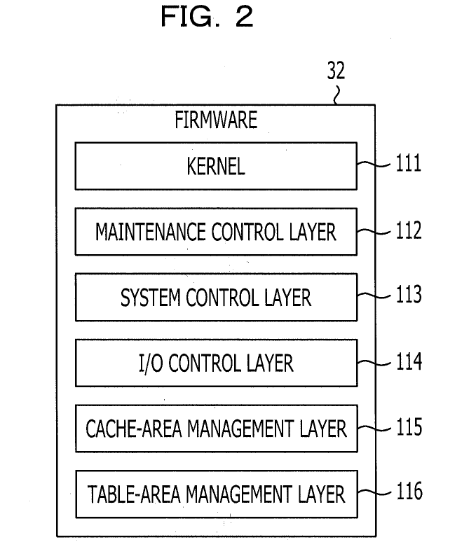

FIG. 2 illustrates the configuration of the firmware 32 of the disk array apparatus 1. The firmware 32 has a kernel 111, which provides basic functions, a maintenance control layer 112, which controls the maintenance of the disk array apparatus 1, and a system control layer 113, which manages the status of the entire disk array apparatus 1.

The firmware 32 includes an I/O control layer 114, which controls the I/O process, a cache-area management layer 115, which manages a cache area 103, and a table-area management layer 116, which manages a table area 102. The CPU 31 operates as part of a memory control unit by executing programs of the firmware 32.

The large-volume memory 33 includes a semiconductor memory, etc., which may be accessed faster than a hard disk. As described above, the memory area of the large-volume memory 33 is partitioned into a system area 101, the table area 102, and the cache area 103. Each area is managed separately as a single unit.

The system area 101 is an area in which data managed by the kernel 111 is stored, and is managed by the kernel 111. The cache area 103 is an area used as a cache memory in which I/O data is temporarily stored, and is managed by the cache-area management layer 115.

The table area 102 is an area in which management information and control information used for managing/controlling the disk array device 1 is stored, and is managed by the table-area management layer 116. The memory pools in the table area 102 hold, for example, information temporarily used by the maintenance control layer 112, the system control layer 113, the I/O control layer 114, etc. to carry out operations (for example, various types of setting information and work data for controlling the device).

The table area 102 and the cache area 103 in the large-volume memory 33 may be changed (the area size may be changed) during operation of the disk array apparatus 1, without turning on or off the power.

An area in the table area 102 that is not used may be released and set as the cache area 103, or, alternatively, an area in the cache area 103 may be set as the table area 102. Such memory areas are controlled by the cache-area management layer 115 and the table-area management layer 116.

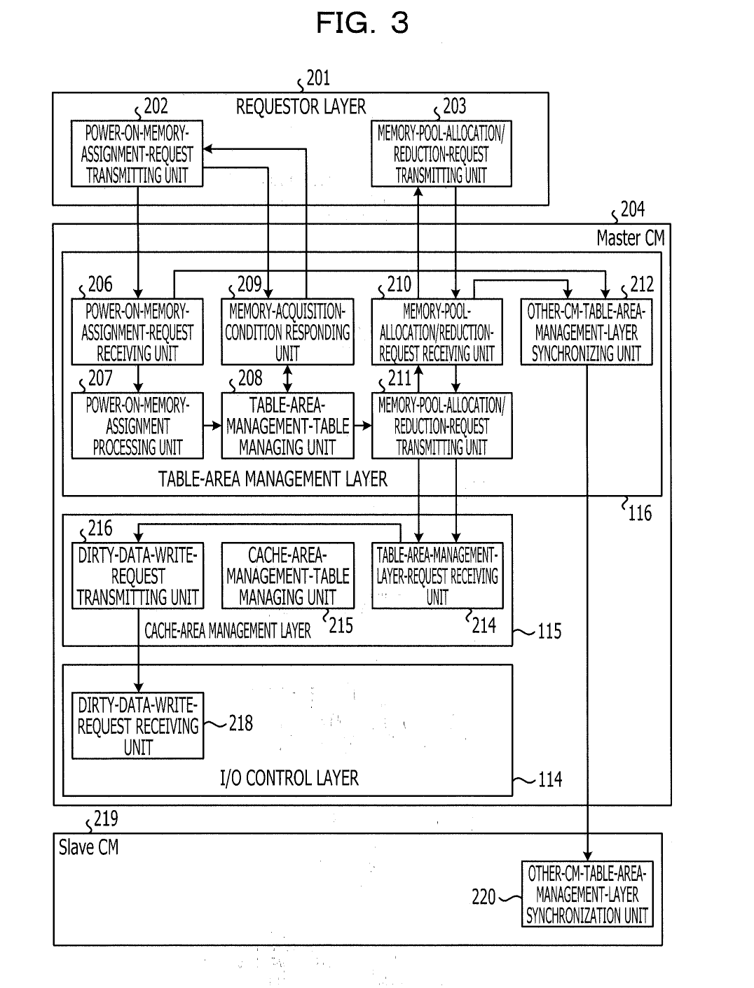

FIG. 3 is a functional block diagram of the controller module 30. The disk array apparatus 1 includes a plurality of controller modules 30, which are capable of communicating with each other.

Among the controller modules 30, the controller module 30 that manages the other controller modules 30 is referred to as “master controller module (master CM) 204” and the other controller modules 30 that are managed by the master CM 204 are referred to as “slave controller modules (slave CMs) 219.”

In FIG. 3, for convenience, the functions of the master CM 204 (functions operated by the master CM 204) and the functions of the slave CMs 219 (functions operated by the slave CMs 219) are illustrated separately. However, the master CM 204 and the slave CMs 219 are interchangeable. Therefore, every controller module 30 has the functions illustrated in FIG. 3, regardless of it being either a master CM 204 or a slave CM 219.

In FIG. 3, a requestor layer 201 is an arbitrary layer that uses the table area 102 in the firmware 32, excluding the kernel 111, the cache-area management layer 115, and the table-area management layer 116. The requestor layer 201 includes a power-ON-memory-assignment-request transmitting unit 202 and a memory-pool-allocation/reduction-request transmitting unit 203.

The power-ON-memory-assignment-request transmitting unit 202 sends to the table-area management layer 116 of the master CM 204 a memory assignment application for applying for the memory volume of the table area 102 to be used by the power-ON-memory-assignment-request transmitting unit 202 when power is turned on.

The memory-pool-allocation/reduction-request transmitting unit 203 sends to the table-area management layer 116 of the master CM 204 a memory allocation/reduction request for requesting the allocation or reduction of a memory pool while the disk array apparatus 1 is in operation.

The table-area management layer 116 includes a power-ON-memory-assignment-request receiving unit 206, a power-ON-memory-assignment processing unit 207, a table-area-management-table managing unit 208, a memory-acquisition-status responding unit 209, a memory-pool-allocation/reduction-request receiving, unit 210, a memory-pool-allocation/reduction-request transmitting unit 211, and an other-CM-table-area-management-layer synchronizing unit 212.

The power-ON-memory-assignment-request receiving unit 206 receives a memory assignment application from the requestor layer 201. The power-ON-memory-assignment-request receiving unit 206 outputs a memory assignment request to the power-ON-memory-assignment processing unit 207 on the basis of the received memory assignment application and outputs an other-CM synchronization request to the other-CM-table-area-management-layer synchronizing unit 212. The other-CM synchronization request is a request for synchronizing the table areas 102 of the master CM 204 and the slave CMs 219.

The power-ON-memory-assignment processing unit 207 performs memory assignment associated with the table area 102 on the basis of the input memory assignment request and outputs the memory assignment result to the table-area-management-table managing unit 208. The table-area-management-table managing unit 208 reflects the memory assignment result on the table-area management table associated with the table area 102.

The memory-acquisition-status responding unit 209 receives a memory-acquisition-status confirmation from the power-ON-memory-assignment-request transmitting unit 202 and sends back a memory-acquisition-status response. At this time, the memory-acquisition-status responding unit 209 inquires the table-area-management-table managing unit 208 about the memory acquisition status and sends back the result of the inquiry as a response.

The memory-pool-allocation/reduction-request receiving unit 210 receives a memory-pool-allocation/reduction request from the requestor layer 201. The memory-pool-allocation/reduction-request receiving unit 210 outputs a memory assignment request to the memory-pool-allocation/reduction-request transmitting unit 211 on the basis of the received memory-pool-allocation/reduction request and outputs an other-CM synchronization request to the other-CM-table-area-management-layer synchronizing unit 212.

The memory-pool-allocation/reduction-request transmitting unit 211 sends a memory-acquisition release request to the cache-area management layer 115 on the basis of the input memory assignment request. Then, the memory-pool-allocation/reduction-request transmitting unit 211 confirms the memory assignment status of the cache-area management layer 115, outputs the memory assignment result to the table-area-management-table managing unit 208, and outputs the memory assignment response to the requestor layer 201 via the memory-pool-allocation/reduction-request receiving unit 210.

The other-CM-table-area-management-layer synchronizing unit 212 sends the received other-CM synchronization request to the other-CM-table-area-management-layer synchronizing units 212 of the slave CMs 219.

The cache-area management layer 115 includes a table-area-management-layer-request receiving unit 214, a cache-area-management-table managing unit 215, and a dirty-data-write-request transmitting unit 216.

The table-area-management-layer-request receiving unit 214 receives a memory-acquisition-release request from the memory-pool-allocation/reduction-request transmitting unit 211 in the table-area management layer 116, performs memory assignment on the basis of the received memory-acquisition-release request, and outputs the memory assignment result to the cache-area-management-table managing unit 215.

The cache-area-management-table managing unit 215 reflects the memory assignment result on the cache-area management table associated with the cache area 103. The table-area-management-layer-request receiving unit 214 outputs a dirty-data-write request associated with the corresponding area to the I/O control layer 114 via the dirty-data-write-request transmitting unit 216 on the basis of the memory assignment result.

A dirty-data-write-request receiving unit 218 of the I/O control layer 114 receives the dirty-data-write request from the cache-area management layer 115. In this way, dirty data stored in an area assigned by the dirty-data-write request and not written in the HDD is written in the hard disk drive with priority.

An other-CM-table-area-management-layer synchronizing unit 220 of each slave CM 219 receives an other-CM synchronization request from the master CM 204 and instructs the other functional units to execute memory assignment that is the same as that in the master CM 204 on the basis of the received other-CM synchronization request.

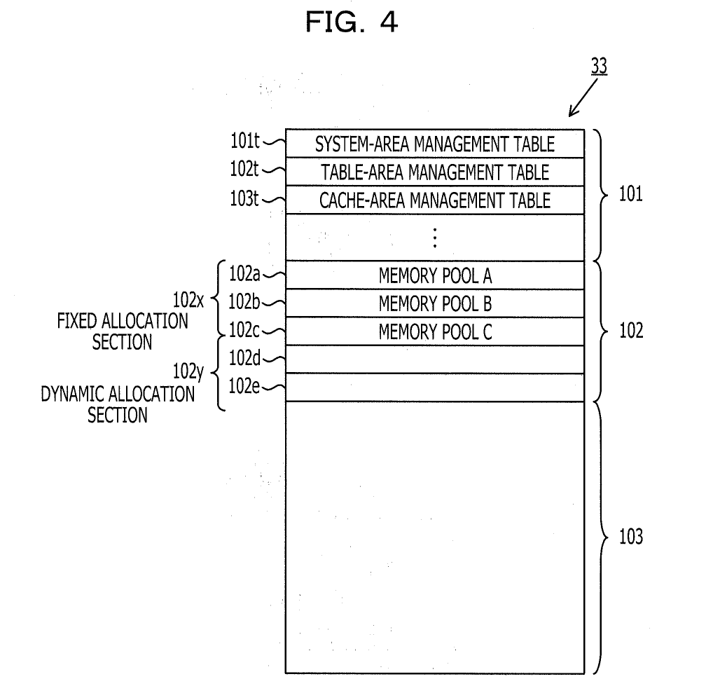

FIG. 4 is a schematic view of the allocation of table areas. As illustrated in FIG. 4, the system area 101 in the large-volume memory 33 is partitioned into a system-area management table 101t for managing the system area 101, a table-area management table 102t in which table-area management information for managing the table area 102 is registered, and a cache-area management table 103t in which cache-area management information for managing the cache area 103 is registered.

The memory pool assignment when power is turned on will be described below. As illustrated in FIG. 4, when power is turned on, a minimum number of memory pools A, B, and C that are most likely to be used as memory areas 102a, 102b, and 102c in a fixed allocation section 102x in the table area 102 are assigned in order.

Memory areas 102d and 102e in a dynamic allocation section 102y in the table area 102 are assigned as memory areas in which memory pools D and E will be allocated. Memory pools other than the memory pools D and E may be allocated to the memory areas 102d and 102e in the dynamic allocation section 102y in accordance with the memory-pool allocation request. In this way, by using two sections in accordance with the use frequency and use pattern, the dynamic allocation section 102y may be efficiently used.

Each table-area management layer 116 of the disk array apparatus 1 according to this embodiment has an interface for performing memory assignment application from each layer so as to assign the memory pools 102a to 102e in the table area 102 when power is turned on.

A function for assigning memory areas in the table area 102 starting from the end position of the system area 101 in the large-volume memory 33, i.e., the starting position (beginning address) of the table area 102, on the basis of a memory assignment application from each layer is provided. A function for assigning memory areas as memory pools A, B, and C, in order, to the memory areas 102a, 102b, and 102c in the fixed position section 102x in the table area 102 is provided.

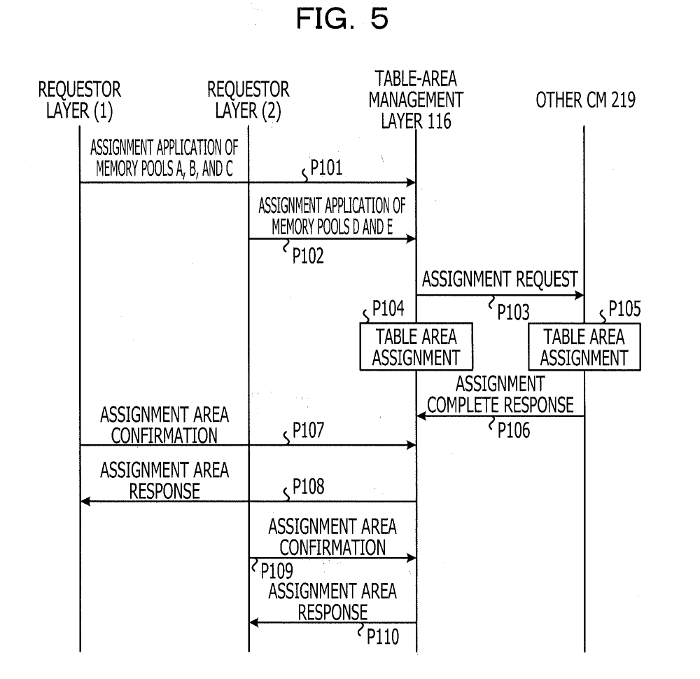

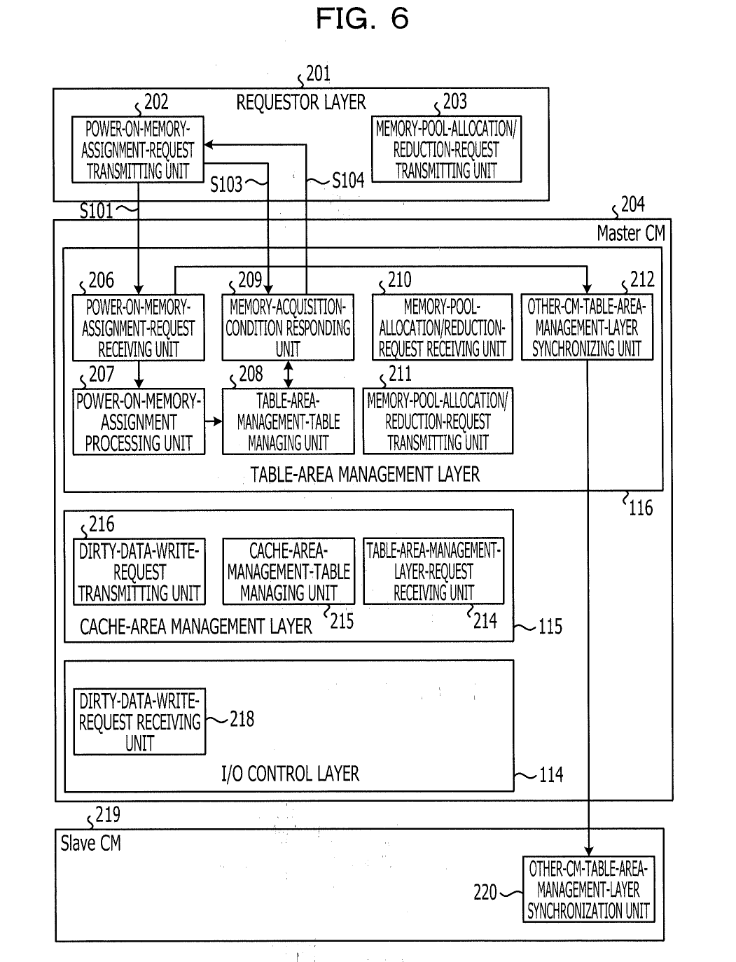

FIG. 5 illustrates the sequence of memory pool assignment when power is turned on. FIG. 6 illustrates memory pool assignment when power is turned on. In this embodiment, assignment is performed on the memory pools A to E, which are most likely to be used.

When the power of the disk array apparatus 1 is turned on, each requestor layer 201, which uses the table area 102 as a memory, carries out memory-pool assignment application S101 to the corresponding table-area management layer 116.

Specifically, a requestor layer (1) applies for the assignment of the memory pools A, B, and C (Operation P101) and assigns, in order, the memory areas 102a, 102b, and 102c in the fixed position section 102x to the memory pools A, B, and C, respectively. A requestor layer (2) applies for the assignment of the memory pools D and E (Operation P102) and assigns the memory areas 102d and 102e in the dynamic allocation section 102y to the memory pools D and E, respectively.

Memory area assignment is performed on the memory areas 102d and 102e in the dynamic allocation section 102y so that the memory pools D and E and other memory pools may be arranged at arbitrary positions. The two memory areas 102d and 102e are described as examples for the dynamic allocation section 102y in this embodiment; however, the number and memory volume of a dynamic allocation section 102y may be set in accordance with the usage status of the disk array apparatus 1.

The memory pools A to E only determine the assignment of the memory areas when power is turned on, and the actual allocation is performed upon reception a memory-pool, allocation request during operation. Thus, the areas assigned for the memory pools A to E may be used as cache areas until a memory-arrangement request is received.

When the memory pools A, B, and C are actually allocated in the fixed allocation section 102x in response to an allocation request of the memory pools A, B, and C, the memory pools A, B, and C are fixed (permanently allocated) in the corresponding memory area, and thus, the memory area is no longer used as a cache area. That is, the memory areas 102a, 102b, and 102c in the fixed allocation section 102x are not released as cache areas since, the memory pools may not be reduced after they are allocated.

In contrast, in the dynamic allocation section 102y in which the memory pools D and E are allocated, the memory pools D and E may be reduced if they are not to be used after they are allocated. Thus, the memory areas 102d and 102e are released as cache areas after the memory pools are reduced and may be used as memory areas for cache again.

A table in which the memory volumes of the memory pools A to E to be used by each requestor layer 201 in accordance with the volume of the corresponding large-volume memory 33 is prepared in advance. The memory-pool assignment application S101 is carried out by each requestor layer 201 referring to this table at start-up and acquiring a memory having a volume appropriate for the condition of the disk array apparatus 1.

Instead, the status (volume of the large-volume memory 33, etc.) of the disk array apparatus 1 at start-up may be detected, and an appropriate memory volume may be automatically calculated. The table in which the memory volumes of the memory pools A to E are stored may be registered by the user in advance and may be included as part of the firmware 32. This table may be provided in the table-area management layer 116, and the requested volume may be written in advance off line.

Next, the table-area management layer 116 sends an other-CM synchronization request (assignment request for another CM) S102 to the table-area management layer 116 of the corresponding slave CM 219 on the basis of the memory-pool assignment application S101 from the requestor layer 201 (Operation P103). The table-area management layer 116 assigns a table area on the basis of the memory-pool assignment application S101 from each requestor layer 201 (Operation P104).

The assignment of the table area 102 is carried out in synchronization with the slave CMs 219 on the basis of the other-CM synchronization request S102 from the table-area management layer 116 (Operation P105). That is, the assignment of the memory pools A to E in this table area 102 (operations S104 and P105) is carried out in synchronization with all of the controller modules in the disk array apparatus 1.

Upon completion of the assignment of the memory pools A to E in the table area 102 is completed on the basis of the other-CM synchronization request S102 from the table-area management layer 116, the slave CM 219 sends an assignment-complete response notifying the completion of the assignment to the table-area management layer 116 (Operation P106).

Upon ending the assignment of the memory pools A to E in the table area 102 carried out in response to the memory-pool assignment application S101 of the memory pools A to E from each requestor layer 201, the assignment of the memory pools in the table area 102 while power is on ends.

In this way, the table-area management layer 116 assigns a memory area from starting position of the table area 102 (end position of the system area 101) as the memory areas 102a, 102b, and 102c in the fixed allocation section 102x and the memory areas 102d and 102e the dynamic allocation section 102y of the table area 102. The end position of the memory assignment is the end position of the table area 102 and the beginning position of the cache area 103.

Upon completion of the memory assignment by the table-area management layer 116, each requestor layer 201 carries out confirmation (memory-acquisition-status confirmation) S103 of the assigned areas of the memory pools A to E in the table area 102 applied to the table-area management layer 116 (Operations P107 and P109).

Then, if the assignment of the memory pools A to E is completed normally in accordance with the application from each requestor layer 201, the table-area management layer 116 sends a response (memory-acquisition-status response) S104 of the assigned area (address) to the corresponding requestor layer 201 (Operations S108 and P110).

Subsequently, the requestor layer 201 recognizes that each address of the memory areas 102a, 102b, and 102c in the fixed allocation section 102x notified by the response S104 respectively corresponds to the memory pools A, B, and C assigned by itself and uses the memory areas 102a, 102b, and 102c as areas for management/control information of the storage apparatus.

The requestor layer 201 recognizes that each address of the memory areas 102d and 102e in the dynamic allocation section 102y notified by the response S104 are areas in which the memory pools D and E, etc. may be allocated and uses the memory areas 102d and 102e as areas for management/control information of the storage apparatus.

Next, assignment of the table area 102 and the memory pools while the disk array apparatus 1 is in operation will be described below. While the disk array apparatus 1 is in operation, one of the memory areas 102d and 102e in the dynamic allocation section 102y used as the cache area 103 is assigned as a memory pool on the basis of a memory-pool assignment request from a predetermined requestor layer 201.

Since the dynamic allocation section 102y according to this embodiment only has acquired two memory areas 102d and 102e, when there is a shortage is memory volume, additional memory pools may be allocated. Therefore, in response to the memory acquisition/release completion from the cache-area management layer 115, the corresponding memory area may be set as the table area 102 and as a management target or a non-management target.

The cache-area management layer 115 has a function for setting a memory area as the cache area 103 and as a management target or a non-management target in accordance with a memory acquisition/release request from the table-area management layer 116.

The cache-area management layer 115 also has a function for requesting control for writing in the HDD with priority in the I/O control layer 114 when dirty data is present in the area that is to be assigned as the table area 102. Dirty data is write pending data which is waiting for the timing of writing in the HDD and is not yet written in.

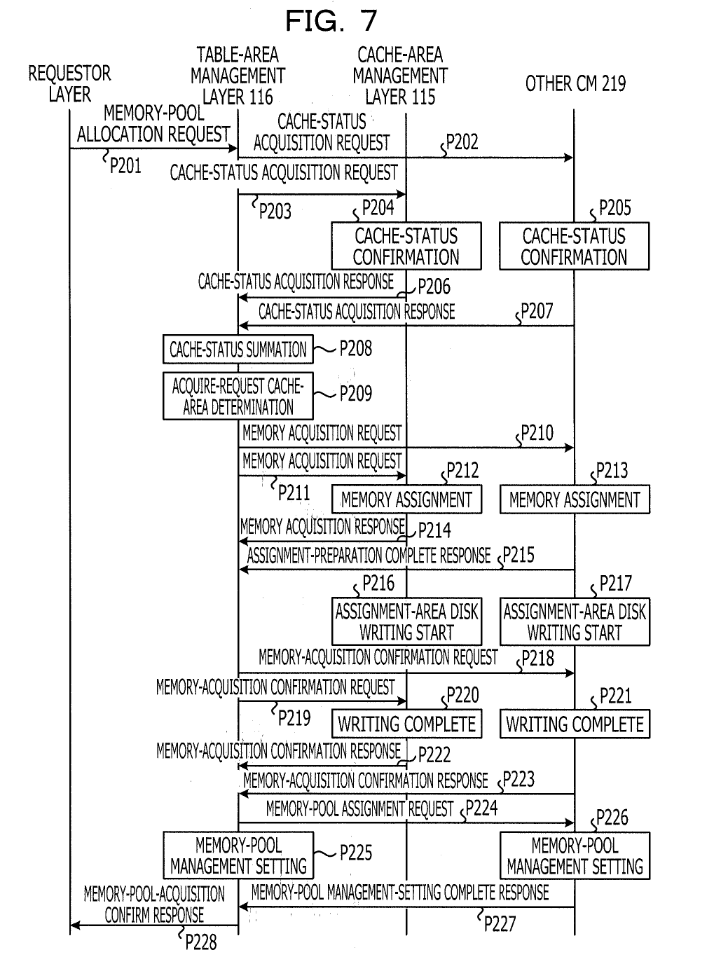

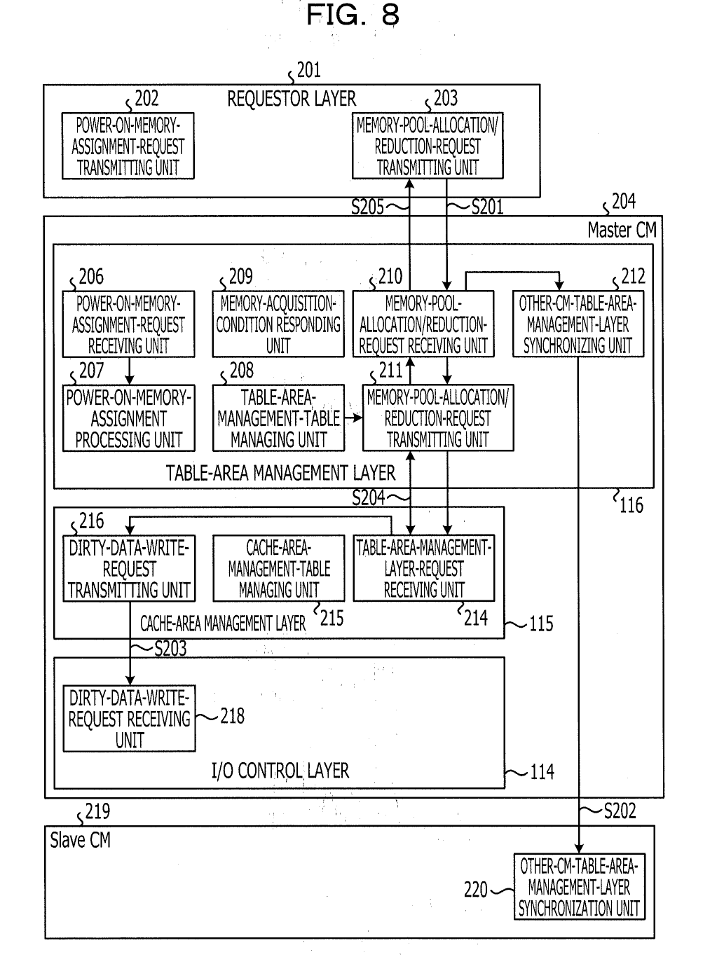

First, memory pool allocation for actively assigning the memory pool E to the dynamic allocation section 102y while the disk array apparatus 1 is in operation will be described below. FIG. 7 illustrates a sequence of memory pool allocation. FIG. 8 illustrates memory pool allocation.

First, while the disk array apparatus 1 is in operation, the requestor layer 201 of which the memory is to be used as the memory pool E requests a memory-pool allocation request S201 to the table-area management layer 116 (Operation P201). In response, the table-area management layer 116 sends a cache-status acquisition request to the cache-area management layer 115 and the table-area management layers 116 of other CMs (slave CMs) 219 (Operations P202 and P203).

The cache-area management layer 115 and the other CMs (slave CMs) 219, which have received the cache-status acquisition request confirm the cache status (Operations S204 and P205). The cache-area management layer 115 and the other CMs (slave CMs) 219 send a cache-status acquisition response to the table-area management layers 116 (Operations P206 and P207).

Each table-area management layer 116 sums up the cache status (Operation P208) and determines an acquisition-request cache area from the memory areas 102d and 102e in the dynamic allocation section 102y (Operation P209). If the memory areas 102d and 102e in the dynamic allocation section 102y are already used, the cache status of other cache areas will be summed up and determined to be used. A detailed method of determining the acquisition-request cache area will be described in the following.

The table-area management layer 116 sends a memory acquisition request to the cache-area management layer 115 and the table-area management layers 116 of the other. CMs (slave CMs) 219 (Operations P210 and P211).

The cache-area management layer 115 and the other CMs (slave CMs) 219 perform memory assignment for acquiring memory areas corresponding to the desired volume and assigning them to the memory pool E (Operations P212 and P213). The cache-area management layer 115 sets a part of the cache area 103 corresponding to the requested memory volume in the table-area management table 102t as a non-management target.

In synchronization with this operation, the other CMs (slave CMs) 219 set a part of the cache area 103 corresponding to the requested memory volume in the table-area management table 102t as a non-management target on the basis of the other-CM synchronization request S202 from the table-area management layer 116.

The cache-area management layer 115 sends a memory acquisition response to the table-area management layer 116 (Operation P214), and the other CMs 219 send an assignment-preparation complete response to the table-area management layer 116 (Operation P215).

In this way, the area to be assigned to the memory pool E is no longer used as the cache area 103. When dirty data is present in the area to be assigned, the cache-area management layer 115 sends a write request S203 to the I/O control layer 114 so that dirty data is written in the HDD with priority. In this way, the dirty data in the area to be assigned is written in the HDD (Operations P216 and P217).

The table-area management layer 116 sends out a confirmation request S204 of the memory acquisition status to the cache-area management layer 115 and the other CMs 219 (Operations P218 and P219). If dirty data remains in the area to be assigned, the cache-area management layer 115 sends out a memory-in-use response S204 in response to the confirmation request S204. In this way, the cache-area management layer 115 and the other CMs 219 writes the dirty data in the HDD (Operations S220 and S221).

If the entire area to be assigned is empty or if the writing of the dirty data in the HDD is completed, the cache-area management layer 115 and the other CMs 219 send a memory-acquisition confirmation response to the table-area management layer 116 (Operations P222 and P223). Upon reception the memory-acquisition confirmation response, the table-area management layer 116 sends a memory-pool assignment request to the other CMs 219 (Operation P224).

The table-area management layer 116 and the table-area management layers 116 of the other CMs 219 perform memory-pool management setting of each of the table-area management table 102t, which is a management target, to use the area to be assigned as the memory pool E (Operations P225 and P226). Upon completion of the memory-pool management setting, the table-area management layers 116 of the other CMs 219 send memory-pool-management-setting completion responses to the table-area management layer 116 of the master MC 204 (Operation P227).

Upon completion of the memory-pool management setting, the table-area management layer 116 sends back a memory-pool-acquisition response S205 to the requestor layer 201 (Operation P228). In this way, the requestor layer 201 may use a memory having a desired volume as the memory pool E for storing management/control information of the disk array apparatus 1.

In this way, the memory pool E, whose allocation is requested, may be allocated to, for example, the memory area 102d, instead of the memory areas 102e in the dynamic allocation section 102y. Thus, the beginning of the memory pool E may be filled inside the table area 102, and thus, efficient allocation in the disk array apparatus 1 is achieved. The memory areas 102e may be used as a cache area until the next allocation request is received.

When the memory area 102d in the dynamic allocation section 102y is unused because the memory pool E is released, the table-area management layer 116 may reallocate another memory pool upon reception of an allocation request the memory pool.

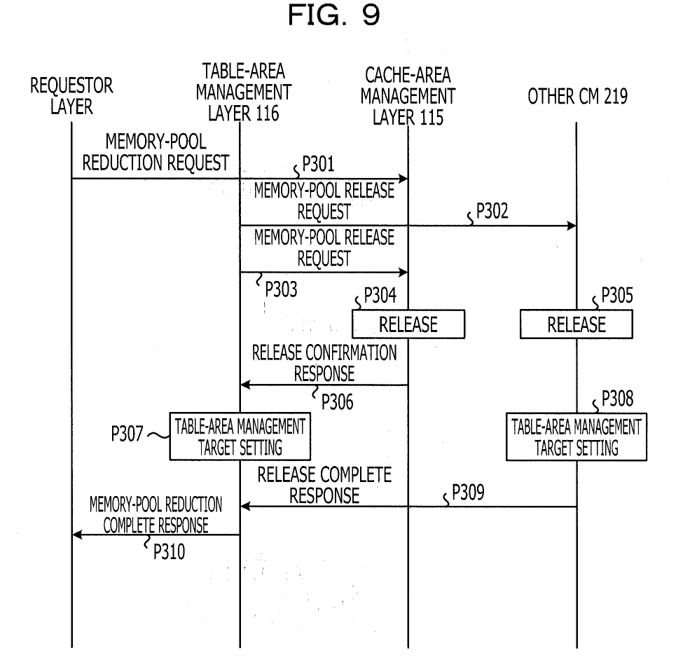

Next, memory pool reduction for actively releasing the memory pool E and assigning the memory pool E to the cache area 103 while the disk array apparatus 1 is in operation will be described. FIG. 9 illustrates the sequence of memory pool reduction.

First, while the disk array apparatus 1 is in operation, the requestor layer 201 in which a memory area acquired as the memory pool E is to be released sends a reduction request of the memory pool E to the table-area management layer 116 (Operation P301). In response to the request, the table-area management layer 116 sends a memory-pool-E release request to the cache-area management layer 115 and table-area management layers 116 of the other CMs (slave CMs) 219 (Operations P302 and P303).

The cache-area management layer 115 that has received the memory-pool-E release request manage and set the memory area whose release is requested to the cache-area management table 103t so as to use this memory area as the cache area 103 and releases this memory area (Operation P304). In synchronization with this operation, the table-area management layers 116 of the other CMs (slave CMs) 219 manage and set the memory area whose release is requested to the cache-area management table 103t so as to release this memory area (Operation P305).

Upon setting the memory area whose release is requested as a management target, the cache-area management layer 115 sends a response confirming the release of the memory pool E to the table-area management layer 116 (Operation P306). Then, the table-area management layer 116 and the table-area management layers 116 of the other CMs 219 set the memory pool E to the table-area management table 102t as non-management target of table area management (Operations P307 and P308).

The table-area management layers 116 of the other CMs 219 send a release completion response of the memory pool E to the table-area management layer 116 of the master MC 204 (Operation P309). Then, the table-area management layer 116 sends back a reduction completion response of the memory pool E to the requestor layer 201 (Operation P310). In this way, the memory area in which the memory pool E is released may be used as the cache area 103.

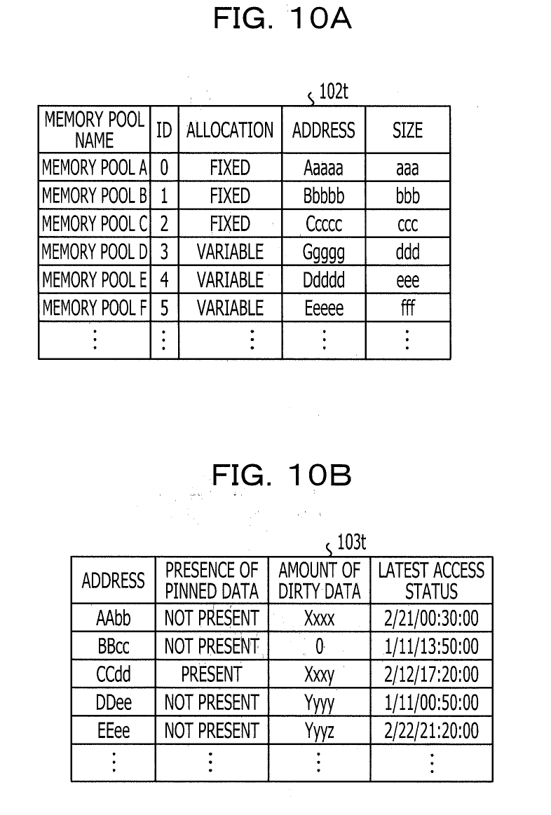

FIG. 10A illustrates an example table-area management table. FIG. 10B illustrates an example cache-area management table. As illustrated in FIG. 10A, assignment information of the memory pools, which is table-area management information, is registered to the table-area management table 102t. For example, memory pool name, memory pool ID, allocation information, address, which is the information on the position in memory unit, and volume may be registered.

For the allocation information, memory pools allocated to the fixed allocation section are registered as “fixed,” and the memory pools allocated to the dynamic allocation section are registered as “variable.” Specifically, the memory pools A to C are registered as “fixed” in the allocation information and are allocated to assigned areas Aaaaa, Bbbbb, and Ccccc, respectively. The memory pools D, E, and F are registered as “variable” in the allocation information and are allocated to arbitrary areas, such as Ggggg, Ddddd, and Eeeee, respectively, as illustrated in FIG. 10A.

Memory pools in the table area 102 may be provided dispersedly in the cache area 103. Thus, the memory pool D is allocated to the address Ggggg, which is newly acquired from the cache area 103.

As illustrated in FIG. 10B, usage information, such as the presence of pinned data, the amount of dirty data, the latest access status, etc. is registered to the cache-area management table 103t. By using the cache-area management table 103t, the table-area management layer 116 sums up the cache status.

In the column of the presence of pinned data, if pinned data is present, “present,” and if pinned data is not present, “not present” will be registered. In the column of dirty data amount, the number of bites will be registered. Although not illustrated, information on the position of the dirty data may be registered to the cache-area management table 103t.

In the latest access status column, the latest data the information was access is registered. Thus, using the latest access status, a memory area in the cache area with a small amount of dirty data may be determined whether it has been accessed most recently, second most recently, or least recently.

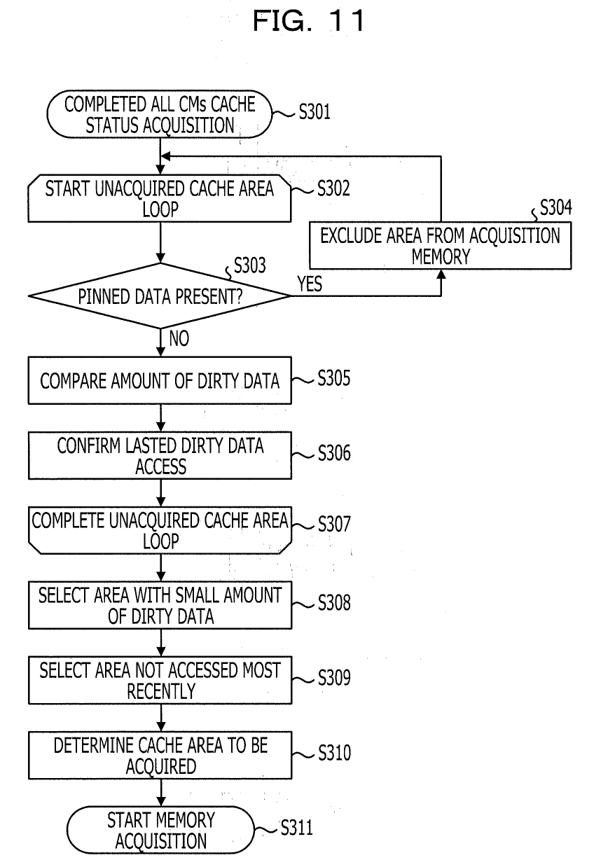

FIG. 11 is a diagram illustrating the determination flow in the acquired-request cache area. The table-area management layer 116 sends a cache-status confirmation request to the cache-area management layer 115 and the other CMs 219 to confirm the cache-area management table 103t. Then, the cache-area management layer 115 and the other CMs 219 acquire the information on the presence of pinned data, the amount of dirty data, the latest access status, etc. and send this to the table-area management layer 116.

Then, upon the completion of the acquisition of the cache status of all CMs (Operation S301), the table-area management layer 116 starts an unacquired-cache-area loop (Operation S302). When pinned data is present in the acquired memory area common to all CMs (YES in Operation S303), the table-area management layer 116 excludes this area from the acquired memory area because it will not be acquired (Operation S304). Thus, by excluding the memory area in the cache area in which the pinned data is present, the pinned data may be protected and the function as a cache memory may be maintained.

If there is not pinned data in the, acquired memory areas (NO in Operation S303), the table-area management layer 116 compares the amount of dirty data in the acquired memory areas (Operation S305).

The table-area management layer 116 uses the cache-area management table 103t to confirm the latest access status (usage status) of the acquired memory areas and confirms whether there has been a latest access (Operation S306). Then, the table-area management layer 116 ends the unacquired-cache-area loop (Operation S307).

The table-area management layer 116 selects areas in which the amount of dirty data is small (Operation S308) and selects acquired memory areas which have not been accessed most recently (Operation S309). The table-area management layer 116 determines the memory area which has not been accessed most recently and has the least amount of dirty data as a cache area to be acquired (Operation S310).

That is, a cache area having the least amount of dirty data among the memory areas in the cache area accessed before the most recently accessed memory area is selected. Thus, by excluding the memory area in the cache area most recently accessed from the selection, a reduction in the accessibility of the cache memory may be suppressed.

The table-area management layer 116 starts memory acquisition (Operation 311) and sends a memory-acquisition request to all the CMs. Thus, a cache area having the shortest HDD writing time may be selected from cache areas having a HDD writing time satisfying the acquisition status, and the memory pool acquisition time may be shortened.

The method of determining such an acquisition-request cache area may be employed in determining memory areas in a dynamic allocation section and increasing the memory pools by newly acquiring memory areas from the cache area 103.

In addition to the example acquisition status described above, i.e., presence of pinned data, usage status, the amount of dirty data, etc., other conditions may also be included.

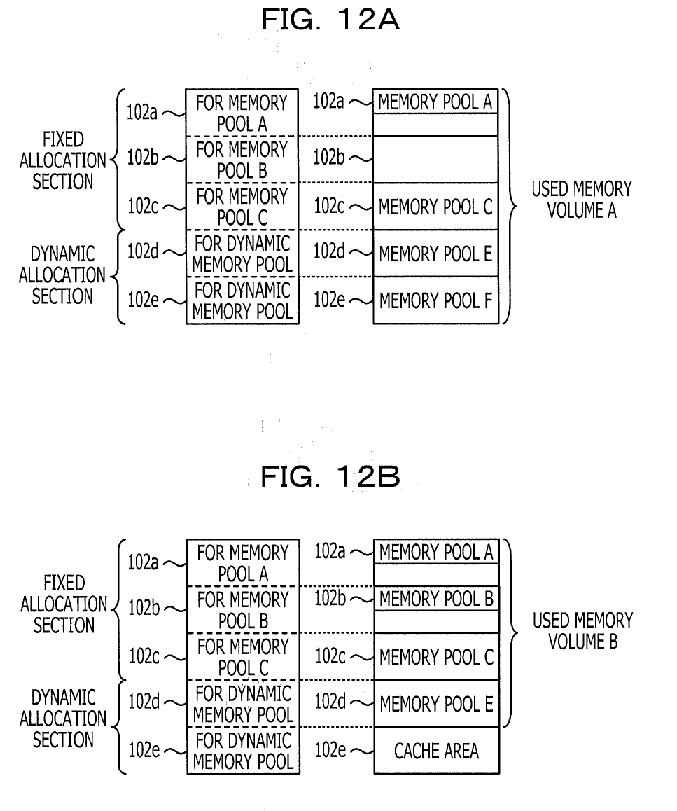

FIGS. 12A and 12B are, schematic views of memory-pool allocation and reduction. In FIG. 12A, the memory areas 102a, 102b, and 102c in the fixed allocation section 102x are respectively assigned for memory pools A, B, and C. The memory areas 102d and 102e in the dynamic allocation section 102y are assigned for dynamic memory pools.

The memory pools A and C, which are acquired from the cache area 103, are allocated to the memory areas 102a and 102c. Although the memory pool B is not allocated in the memory area 102b for the memory pool B and is acquired from the cache area 103 but is unused.

The memory pools E and F, which are acquired from the cache area 103, are allocated to the memory pools 102d and 102e in the dynamic allocation section 102y. Thus, the used memory volume A is equal to the sum of the volumes of the five memory pools.

In FIG. 12B, the memory areas 102a, 102b, and 102c in the fixed allocation section 102x are respectively assigned to the memory pools A, B, and C. The memory areas 102d and 102e in the dynamic allocation section 102y are assigned to dynamic memory pools. The memory pools A and C acquired from the cache area 103 are respectively allocated to the memory areas 102a and 102c.

The memory pool E, which is acquired from the cache area 103, is allocated to the memory areas 102d in the dynamic allocation section 102y. The table-area management layer 116 releases the memory pool F, which is illustrated in FIG. 12A, to set the memory area 102e in the dynamic allocation section 102y as “unused.” Thus, the used memory volume B equals to the sum of the volumes of the four memory areas; since the memory area 102e is unused, it may be efficiently used as the cache area 103.

Subsequently, the table-area management layer 116 may reallocate other memory pools to the memory area 102e upon receiving an allocation request for other memory pools.

As described above, with the disk array apparatus 1 according this embodiment, by assigning a minimum volume of information storage area (table area) for allocating memory pools and by efficiently assigning the information storage areas in response to an allocation request while the disk array apparatus 1 is in operation, efficient acquisition from the cache area 103 is possible in a short amount of time. Thus, an excessively large information storage area does not have to be assigned and maintained.

Thus, the cache area 103 may be maximized with in the limited memory volume in a memory unit. That is, the large-volume memory 33 may be used as a cache memory to a maximum extent in accordance with the status of the large-volume memory 33, and the performance of the disk array apparatus 1 may be improved.

Since the allocation or reduction of memory pools may be carried out independently from the status of the disk array apparatus 1 and while the disk array apparatus 1 is in operation, non-stop operation of a disk array apparatus, which is often configured as a social system, may be achieved, and flexible operation of the disk array apparatus 1 is possible while maintaining high reliability and high availability.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage apparatus configured to store data received from a host system in a drive unit, comprising:
a memory unit partitioned into a cache area configured to temporarily store data read out from the drive unit and data to be written in the drive unit and an information storage area assigned for a memory pool configured to hold information for internal processing of the storage apparatus;
an information-storage-area management table in which information-storage-area management information including position information on the memory pool in the memory unit is registered;
a cache-area management table in which cache-area management information including usage status of the cache area is registered; and
a memory control unit configured to acquire a memory area in the cache area having the least amount of write pending data in a pending state for writing in the drive unit by referring to the cache-area management table when the memory pool is allocated in the memory unit while the storage apparatus is in operation, to allocate the memory pool in the acquired memory area, and to set the allocated memory pool in the information-storage-area management table.

2. The storage apparatus according to claim 1,
wherein the memory control unit releases the memory pool acquired while the storage apparatus is in operation and performs dynamic allocation to reallocate another memory pool.

3. The storage apparatus according to claim 2,
wherein the memory control unit partitions the entire memory area in the information storage area into a first section and a second section and manages the first section and the second section, and
wherein the first section is a fixed allocation section in which the memory pool is allocated in a fixed manner, and the second section is a dynamic allocation section in which the memory pool is dynamically allocated.

4. The storage apparatus according to claim 1,
wherein the acquired memory area does not include non-writable data stored because writing thereof to the driving unit is not allowed.

5. The storage apparatus according to claim 2,
wherein the acquired memory area does not include non-writable data stored because writing thereof to the driving unit is not allowed.

6. The storage apparatus according to claim 3,
wherein the acquired memory area does not include non-writable data stored because writing thereof to the driving unit is not allowed.

7. The storage apparatus according to claim 1,
wherein the acquired memory area is a memory area in the cache area having a minimum amount of write pending data waiting to be written in the drive unit selected among memory areas in the cache area accessed before another memory area accessed most recently.

8. The storage apparatus according to claim 2,
wherein the acquired memory area is a memory area in the cache area having a minimum amount of write pending data waiting to be written in the drive unit selected among memory areas in the cache area accessed before another memory area accessed most recently.

9. The storage apparatus according to claim 1,
wherein the position of the non-writable data in the memory area, the position of the write pending data, or the amount of write pending data, or any combination thereof is registered in the cache-area management table.

10. The storage apparatus according to claim 2,
wherein the position of the non-writable data in the memory area, the position of the write pending data, or the amount of write pending data, or any combination thereof is registered in the cache-area management table.

11. A storage control device configured to control a storage apparatus that stores data received from a host system in a drive unit, the storage control device comprising:
a memory unit partitioned into a cache area configured to temporarily store data read out from the drive unit and data to be written in the drive unit and an information storage area assigned for a memory pool configured to hold information for internal processing of the storage apparatus; and
a memory control unit configured to acquire a memory area in the cache area having the least amount of write pending data in a pending state for writing in the drive unit by referring to a cache-area management information including usage status of the cache area is registered when the memory pool is allocated in the memory unit while the storage apparatus is in operation, to allocate the memory pool in the acquired memory area, and to set the allocated memory pool in information-storage-area management information including position information on the memory pool in the memory unit.

12. The storage control device according to claim 11,
wherein the memory control unit releases the memory pool acquired while the storage apparatus is in operation and performs dynamic allocation to reallocate another memory pool.

13. The storage control device according to claim 12,
wherein the memory control unit partitions the entire memory area in the information storage area into a first section and a second section and manages the first section and the second section, and
wherein the first section is a fixed allocation section in which the memory pool is allocated in a fixed manner, and the second section is a dynamic allocation section in which the memory pool is dynamically allocated.

14. The storage control device according to claim 11,
wherein the acquired memory area does not include non-writable data stored because writing thereof to the driving unit is not allowed.

15. The storage control device according to claim 12,
wherein the acquired memory area does not include non-writable data stored because writing thereof to the driving unit is not allowed.

16. The storage control device according to claim 13,
wherein the acquired memory area does not include non-writable data stored because writing thereof to the driving unit is not allowed.

17. The storage control device according to claim 11,
wherein the acquired memory area is a memory area in the cache area having a minimum amount of write pending data waiting to be written in the drive unit selected among memory areas in the cache area accessed before another memory area accessed most recently.

18. The storage control device according to claim 12,
wherein the acquired memory area is a memory area in the cache area having a minimum amount of write pending data waiting to be written in the drive unit selected among memory areas in the cache area accessed before another memory area accessed most recently.

19. The storage control device according to claim 11,
wherein the position of the non-writable data in the memory area, the position of the write pending data, or the amount of write pending data, or any combination thereof is registered in the cache-area management table.

20. The storage control device according to claim 12,
wherein the position of the non-writable data in the memory area, the position of the write pending data, or the amount of write pending data, or any combination thereof is registered in the cache-area management table.
